(19) United States
(12) Patent Application Publication
(10) Pub. No.: US 2013/0279497 A1
(43) Pub. Date: Oct. 24, 2013

(54) METHOD FOR CORRELATING MESSAGES ACROSS MULTIPLE PROTOCOLS IN A TELECOMMUNICATION NETWORK

(71) Applicants: SUBHASH VERMA, Fremont, CA (US); RAO NASIR KHAN, Kitchener (CA); RAJEEV ARYA, NOIDA (IN); VISHAL SHARMA, Noida (IN)

(72) Inventors: SUBHASH VERMA, Fremont, CA (US); RAO NASIR KHAN, Kitchener (CA); RAJEEV ARYA, NOIDA (IN); VISHAL SHARMA, Noida (IN)

(21) Appl. No.: 13/861,408

(22) Filed: Apr. 12, 2013

Related U.S. Application Data
(60) Provisional application No. 61/635,096, filed on Apr. 18, 2012.

(51) Int. Cl. H04L 29/06

(52) U.S. Cl. CPC H04L 69/18
USPC 370/352

(57) ABSTRACT

A method for correlating a plurality of messages conforming to different protocols and associated with a common communication call in a communication network. The method comprising extracting an information from a message, extracting a protocol specific identifier, forming a plurality of protocol specific queues, forming a correlation ID using the information extracted from the message and the protocol specific identifier of the message, such that the messages associated with the same communication call have same correlation ID and forming a call specific queue comprising of messages extracted from the plurality of protocol specific queues associated with the same common communication call and having same correlation ID. The method further includes processing of messages from the call specific queue with FIFO criterion.

### CROSS-REFERENCE TO RELATED APPLICATIONS

This application claims the benefit of U.S. Provisional Application Ser. No. 61/635,092, filed on Apr. 18, 2012, the entire content of which is hereby incorporated by reference.

### FIELD OF THE INVENTION

The present invention relates generally to monitoring of messages in a telecommunication network, and more particularly to a method for correlating messages conforming to multiple protocols in a communication call.

### BACKGROUND OF THE INVENTION

Telecommunication technologies have evolved over the past years from simple push button landline telephones to cell phones, internet, and VOIP. These technological developments provide extensive communication services across internet, telephone, mobile phone and several other devices. Additionally, Wi-Fi, Bluetooth have added mobile element to the communications. Telecommunication has grown to become overlapping between these technologies to serve different devices simultaneously.

A single communication call from a user device may be processed using different technologies to reach to a destination device. For example as shown in FIG. 1, a ‘click to call’ service offered by websites to directly connect a user's phone to the website owner's phone. The website takes the phone number of the user and send it to a server by internet over HTTP protocol. The internet server calls the website owner's phone via network node which uses SIP and SS7 protocols. Similarly the internet server also connect to the user mobile phone via mobile network tower using SIP and SS7 protocols and then connects the two phone numbers enabling the talk between the user and the website owner. A single call involves the messages to process through HTTP, SIP and SS7 signaling protocols. Messages from multiple protocols are processed simultaneously in a single call.

The multi-protocol behaviour also exists in any domains which involves processing of messages or data coming from different formats or different sources but are related to the same business entity. For example in the healthcare domain as shown in FIG. 2 a patient may visit different hospitals ‘Hospital 1’, ‘Hospital 2’ or ‘Diagnostic Center 1’ and ‘Diagnostic Center 2’ for performing various treatments or conducting tests prescribed by a medical practitioner. All the test reports, medicines prescribed, treatment done and other medical information for the patient is available in different hospitals, diagnosis centers etc in different formats. This combined information is useful for a medical practitioner to understand the medical history of the patient. The EMRs (Electronic Medical Records), in different EMR message formats like HL7, Dicom, etc which are obtained from different machines or hospitals may be stored on an application server for further use. Message for a specific patient could come from different EMR systems and needs correlating the medical information across these different interfaces to the same “patient” record.

In a multi-protocol environment, messages for a specific call can come from different sources/network elements that use different protocols. For the successful processing of the call, these different messages need to be processed within the context of the same call. Correlating the messages across multi-protocols is necessary in such environments.

Several correlating methods are exists in prior art for example U.S. Pat. No. 5,867,558 discloses a method for remote collection of signalling messages for routing analysis and trouble detection. The method comprises extending a copy of each signalling message processed by a particular signal transfer point to an interface unit. The interface unit relays “of interest” messages to a signal monitoring system (SMS) in accordance with a pre-determined filtering protocol. In the SMS, messages are correlated in accordance with a pre-defined correlating protocol. The correlated signalling messages are subsequently retrieved by an OSS technician for analysis and updates.

Similarly EP 1774725 A2 discloses methods and systems for automatically correlating signalling message priority and IP priority. A priority level of a signalling message (MSU2) may be determined based on a priority parameter in the signalling message (MSU2) or a user based priority. The signalling message (MSU2) is encapsulated in an IP packet. A priority level in the IP packet is set based on the priority level determined for the signalling message.

Another document U.S. Pat. No. 6,765,990 discloses database-driven methods and systems for database driven real time call tracing are disclosed. Signaling messages are copied from signaling link interface modules. The copied messages are sent to a database. A server located remotely from the database sends a query to the database for a real time call trace. The database is searched for messages that match the search criteria. If no messages are located in the historical data stored in the database, data entering the database is analyzed in real time.

The prior art teaches methods of correlating messages from multiple protocols which needs the persistence of information about different protocol inputs related to one call or entity to a database. The information about each message is stored in a database and the database is accessed in every step of further processing. The databases may be located at remote servers and also add on to the cost of infrastructure and maintenance of servers. In database driven methods, the systems achieve correlation between messages from various protocols through storage of information about these messages in a persistent database. When a new message event is received, the database is looked up to find the relevant call into whose context this new protocol message should be processed. Furthermore, the database may be updated with information from the newly received protocol message input for processing of future messages. When the number of protocols increases, that are required to process one call, such systems become very inefficient in managing that. This is because every interaction is saved into a database somewhere and then correlated from there. The database based method of correlation proves to be expensive as it requires information to be persisted into and looked up from databases every time a protocol message arrives.

Another method of correlation available in prior art requires arriving protocol inputs to block their protocol queues while another message from a different protocol for the same communication call is being processed. When the messages from one protocol (say SIP) are being processed, the messages from a second protocol (say SS7) are blocked and have to wait till the processing of the messages of SIP protocol is over. The messages are blocked and have to be stored in memory before processing. The messages are processed by protocol specific queues and not by the call specific queues with FIFO (First In First Out) criterion. This protocol queue blocking method has issues of unsteady and lower performance of the system due to head-of-line blocking problems. The blocking may also add to the load of the memory in terms of the storage.

In view of the limitations inherent in the available methods of correlation messages from multi-protocols in a telecommunication call, there exists a need for an improved method of correlation messages, capable of overcoming disadvantages inherent in conventional methods in a fast, robust, cost effective, secure, and environmental friendly manner. The present invention fulfils this need and provides further advantages as described in the following summary.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent therein.

In one aspect, the present invention provides a method for correlating messages conforming to different protocols and associated with a common communication call in a communication network. The method comprising steps of extracting an information from a message, extracting protocol specific identifier to identify the protocol to which the message conforms, forming a plurality of protocol specific queues, forming a correlation ID using the information extracted from the message and the protocol specific identifier of the message, such that the messages associated with the same communication call have same correlation ID and forming a call specific queue comprising of messages associated with the same common communication call and having same correlation ID.

In another aspect the present invention provides a method comprising, the processing of messages from the call specific queue with FIFO criterion.

In yet another aspect the present invention provides a method for correlating messages conforming to different protocol, where the messages are telecom messages and the protocols may be telecom and messaging protocols from a list of a SIP, a HTTP, a MGCP, a Diameter, a CAP, a MAP, an INAP, a SMTP, a SMPP protocols.

In another aspect the present invention provides a method for correlating data conforming to different formats and associated with a common communication in a communication network.

In another aspect the present invention provides the correlation ID is saved in a memory of a system where the method is applied.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description taken in conjunction with the accompanying drawings in which:

FIG. 1 illustrates a schematic view of a click to call telecommunication involving multi-protocol messages;

FIG. 2 illustrates a schematic view of a multi-protocol environment in healthcare domain;

FIG. 3 illustrates a flowchart of a method for correlating messages conforming to different protocols and associated with a common communication call in a communication network, according to one embodiment of the present invention;

FIG. 4 illustrates the schematic diagram of components of the system which uses the method of the present invention, according to one embodiment of the present invention; and

FIG. 5 illustrates a schematic view of message flow in the system which uses the method of the present invention, according to one embodiment of the present invention.

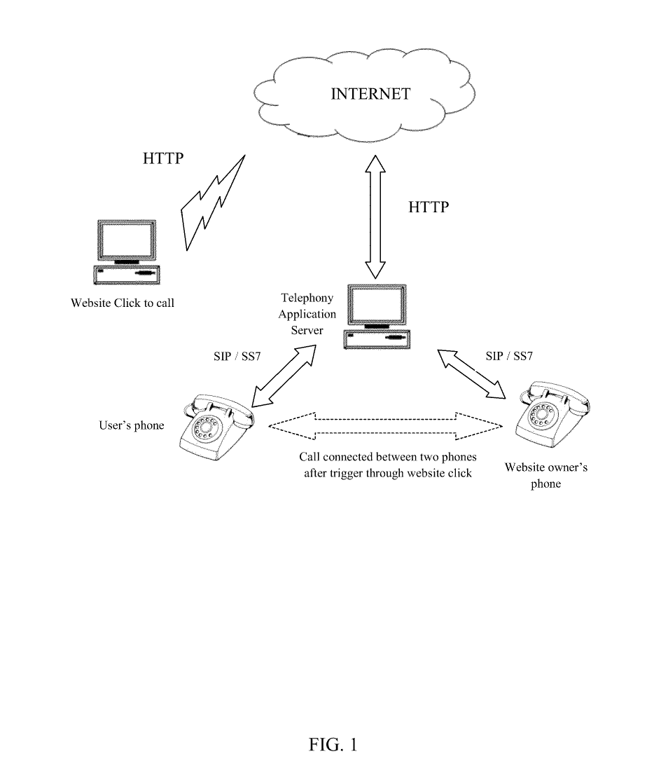

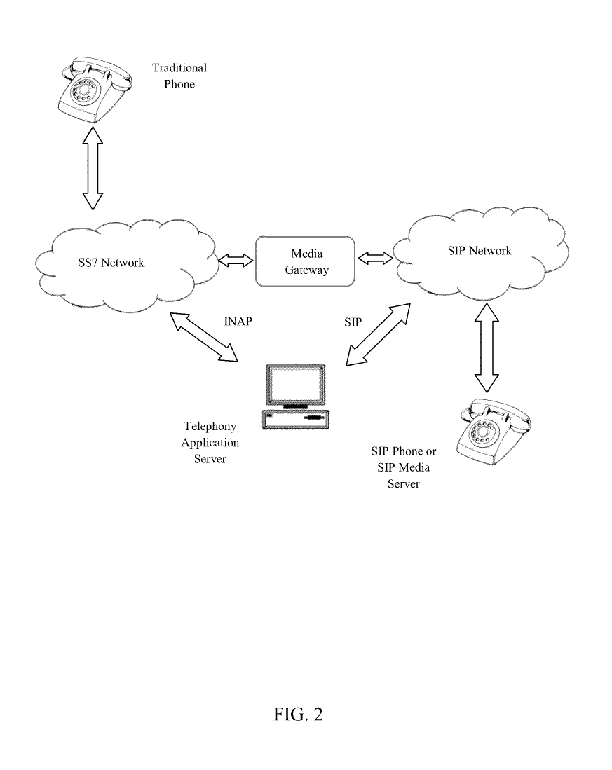

Like reference numerals refer to like parts and steps throughout the several views of the drawings.

### DETAILED DESCRIPTION OF THE DRAWINGS

In the following description, for purposes of explanation, numerous specific details are set forth in order to provide a thorough understanding of the present invention. It will be apparent, however, to one skilled in the art that the present invention may be practiced without these specific details.

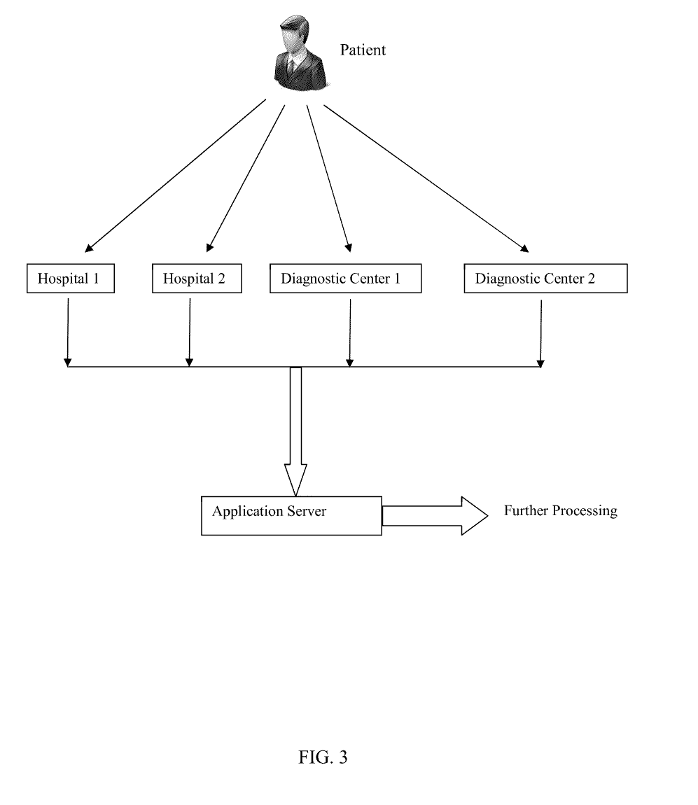

Referring to FIG. 3 which illustrates a flowchart of a method 100 for correlating messages conforming to different protocols and associated with a common communication call in a communication network, according to one embodiment of the present invention. The method 100 starts with step 110 of extracting information from a message. The information may include source indicators, destination indicators and other important parameters, which may be used in further steps of the method 100. In next step 120 protocol specific identifier is extracted from the message to identify the protocol to which the message conforms. The protocol specific identifier is already present in the message and is extracted at this step. All the messages conforming to the same protocol associated with the common communication call, have the same protocol specific identifier. In one embodiment the steps 110 and 120 may be performed as a single step and the information extracted may contain the protocol specific identifier which may be separated from the information when required.

In step 130 a plurality of protocol specific queues may be formed, such that messages having same protocol specific identifier are in same queue. Different messages conforming to different protocols are in separate queues. Next in step 140 a correlation ID is formed using the information extracted from the message and the protocol specific identifier of the message, such that the messages associated with the same communication call have same correlation ID.

Step 150 is forming a call specific queue comprising of messages extracted from the plurality of protocol specific queues associated with the same common communication call and having same correlation ID. The messages are queued in a call specific queue such that the messages which arrive first are processed first irrespective of the protocol they belong to. This prevents the blocking of protocol specific queue messages.

In next step 160 the messages from the call specific queue are processed using a FIFO criterion.

In one embodiment the message may be a telecom message in a telecommunication network and the protocols may be telecom and messaging protocols from a list of SIP, HTTP, MGCP, Diameter, CAP, MAP, INAP, SMTP, SMPP protocols or a combination of different protocols.

In another embodiment the message may be data and the protocols may be formats of the data. The data may be obtained from multiple sources and may be in different formats which are correlated for a single entity for further processing.

The step 110 and 120 of extracting information and the protocol specific identifier from the message may be done based on a pre-defined set of rules. The rules specify what information has to be extracted from a message. The rules are formed based on the requirements of the system which processes the messages. In one embodiment the pre-defined set of rules are different for different protocols. Each of the protocol involved in the common communication call, has its own set of rules which are applied to the messages conforming to respective protocols to extract the information and protocol specific identifiers from the messages. In another embodiment all the protocols may have same set of rules for extracting the information and the protocol specific identifiers from the message. The key to the message is the protocol specific identifier that is extracted as per configured rules. If this succeeds the message is deposited to protocol specific queues and may then be picked up for processing by protocol specific thread pool.

In one embodiment the method may also identify specific protocol elements that are unique and can be correlated across protocols, and may be made available as configuration during the system setup. This helps to efficiently assign calls to the same thread pool on the same server and co-relate them in case they are handled on different servers.

The forming of the correlation ID is also done based on a pre-defined set of rules. The information extracted in step 110 and the protocol specific identifier extracted in step 120 is used to form the correlation ID. The formula to form the correlation ID is based on rules which tell what information has to be used and how to be used to form the common identifier which is correlation ID. In one embodiment the pre-defined set of rules for the formation of correlation ID from the information extracted and the protocol specific identifier may be different for different protocols.

In another embodiment of the present invention the set of rules for forming the correlation ID from the information and the protocol specific identifier extracted may be same for all different protocols.

The correlation ID may include a plurality of call context specific identifiers such as message source identifier, destination identifier etc. The correlation ID is saved in a memory of a system where the method 100 is applied. This eliminates the need of an external database for the correlation process and saves a lot of time and resources. The correlation ID may be numeric, alpha-numeric, or also contain special characters. It is dependent on the information available in the messages. The key point is that the correlation ID is common for all messages across the different protocols in the common communication call.

The method 100 of the present invention, further comprising mapping of the protocol specific identifiers from each of the different protocols with the correlation ID. The protocol specific identifiers extracted from messages in step 120 are mapped with the formed correlation ID and stored in the memory of an application server which runs the method 100.

The method 100, further comprising routing the subsequent messages by identifying the protocol specific identifier and using the mapping of the protocol specific identifiers with the correlation ID. The first few messages from each of the protocols received by the application server are used for extracting the information and the protocol specific identifier and then the correlation ID. Once the correlation ID is formed and the mapping of protocol specific identifier is done with correlation ID, the subsequent messages need not be processed through all the steps of the method 100. The protocol specific identifier of the subsequent message is extracted and this is mapped with correlation ID using the mapping done from earlier messages. The subsequent messages then be routed based on the business logic of the application server without again forming the correlation ID. This is also one of the major advantages of the method 100 of the present invention. It saves the time and load on memory for repeating the steps for subsequent messages.

The method 100 may be implemented on a system such as an application server which may be located at any one of the network node of the telecommunication network.

The method 100 of the present invention neither requires persistence of protocol messages in databases, nor it cause head-of-line blocking in protocol specific queues. The method 100 uses an in-memory mechanism to allow in-memory processing of calls happens in a multi-protocol environment without head-of-line blocking, and thereby increasing the performance of the method.

The proposed method utilizes indices and other related information already available in protocol messages, to correlate different protocol legs together, and this happens in memory, removing any external database dependency. In converged applications multiple telecom and messaging protocols like SIP, HTTP, MGCP, Diameter, CAP, MAP, INAP, SMTP, SMPP etc. are used. The method of present invention makes may make it very easy to correlate different protocol legs and may also provides a mechanism to ensure that related messages for a call on different protocols are not blocked for processing.

In a nutshell if any application server requires multiple protocols that can relate to the same call then this method 100 can eliminate the use of external synchronization mechanisms like database. This solution can be used to correlate protocol specific messages in memory and thus provide for efficient multi-protocol call processing.

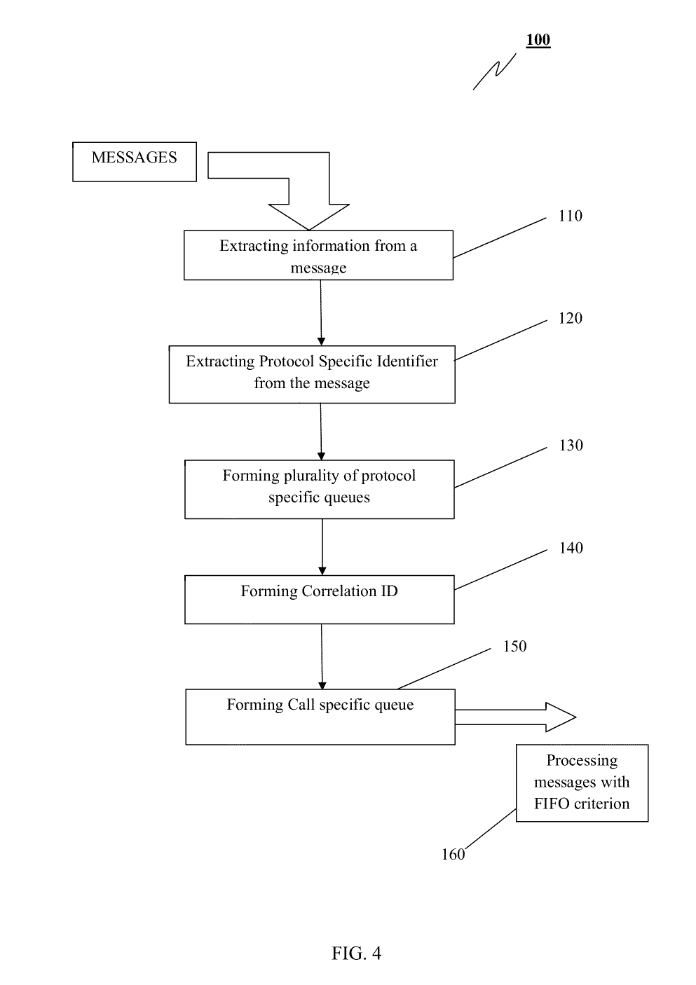

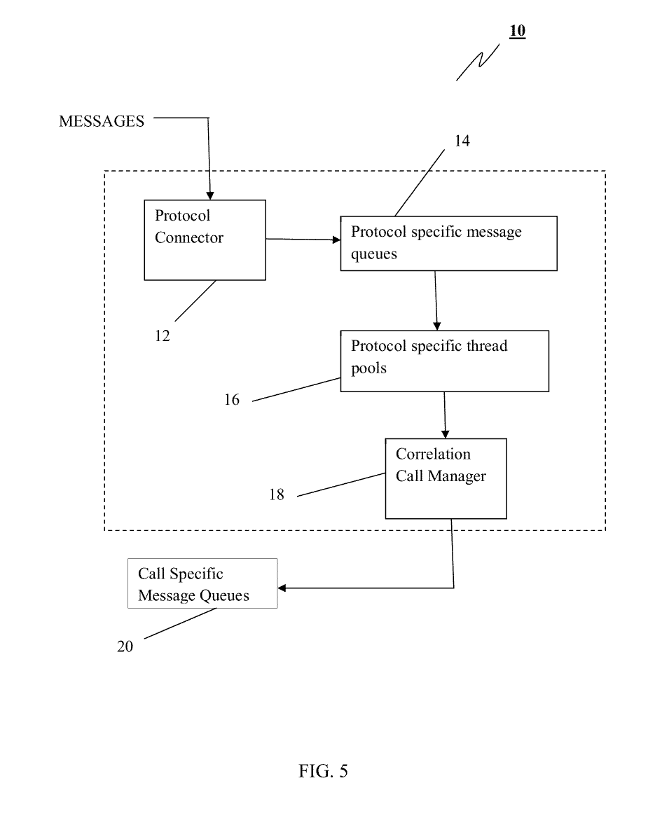

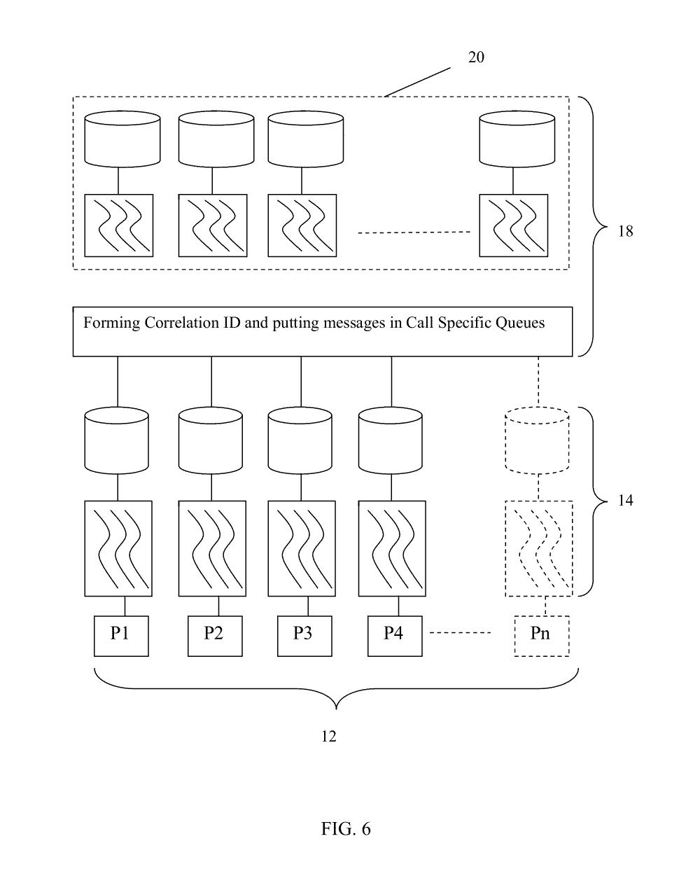

Referring to FIGS. 4 and 5 which illustrate the schematic diagram of components and message flow of the system 10 which uses the method 100 of the present invention, according to one embodiment of the present invention. The system includes protocol connectors 12, protocol specific message queues 14, protocol specific thread pools 16 and a correlation call manager 18 which processes the messages and gives call specific message queues 20.

The protocol connectors 12 have protocol specific stacks and handle protocol specific messages and find the information required. Different protocols have different protocol connectors. As shown in FIG. 5, various protocols like SIP, HTTP, INA etc have their respective protocol connectors P1, P2, P3 . . . Pn. The protocol connectors 12 form protocol specific queues 14 containing messages conforming to same protocol. Protocol connectors 12 use protocol specific thread pools 16 for processing received messages. Protocol specific queues 14 are used to process received protocol specific messages in a FIFO fashion in conjunction with protocol specific thread pools 16. The correlation call manager 18 correlates various related protocol specific call legs. It works on sanitized messages with indices extracted from protocol specific message queues and forms the call-specific message queues 20.

Protocol connectors reference a higher level call-specific correlation function to identify call association. The correlation ID is used by correlation call manager 18 to extract associated messages from protocol specific message queues 14 to form the call-specific message queues 20.

The components work in a hierarchical fashion. Protocol connectors 12 receive the messages and process them. If a message is processed correctly (there are no parsing errors) the protocol specific data structures are created by the connector. The protocol specific identifier is extracted as per configured rules. If this succeeds the message is deposited to protocol specific queues 14 and is then picked up for processing by protocol specific thread pool 16. Till this point there is no contention between different protocol messages. After this the call correlation manager 18 picks up specific call related messages from different protocol specific queues 14 and forms call specific message queues 20, then processes these messages under the resources (threads, queues, etc.) assigned for each call as required by the configuration.

This invention is designed for environments that support multiple protocols and that have cases where a call or business entity may have information coming in from more than one protocol. This method is generic for all environments where information can arrive in different formats for a specific business entity. The method while implementing does not require any specific computer language, operating system or domain for implementation. A representative implementation was done using Java on Solaris 10 OS.

To implement the method 100 of the present invention, a protocol specific stack will be required and configured to receive (and send) protocol specific messages. An example may be SIP stack or SS7 stack. A software function may be written that uses the stack such that call-backs will be triggered when messages are parsed. The software functions, by virtue of contacting call correlation manager 18 configuration, will know how to form the correlation ID into the relevant call. This correlation ID will be common to the call messages. After this processing, the message will be deposited into the protocol specific queue 14.

Independent threads will then pick up the messages and then process them in context of the call manager. At this stage the messages will be categorized not under protocols but under a call (that is, the higher level business entity spanning across protocols). The call correlation manager 18 will then invoke the specific handlers for these messages. These handlers are typically the application code that involve business logic and are outside the scope of this invention.

The system may include standard components like processor, memory, available and used in the state of the art for the method to be implemented.

It is to be noted here that the method of the present invention has been described to be implemented in telecommunication domain, however it can be easily applied to other domains where messages or data is received from multiple sources or conform to different protocols or have different formats but are associate with a common call or instance.

Although a particular exemplary embodiment of the invention has been disclosed in detail for illustrative purposes, it will be recognized to those skilled in the art that variations or modifications of the disclosed invention, including the rearrangement in the steps of the method, changes in sequence, variations in steps may be possible. Accordingly, the invention is intended to embrace all such alternatives, modifications and variations as may fall within the spirit and scope of the claims of the present invention.

The exemplary embodiments described herein detail for illustrative purposes are subject to many variations of structure and design. It should be emphasized, however that the present invention is not limited to particular method for correlating a plurality of messages conforming to different protocols, as shown and described. Rather, the principles of the present invention can be used with a variety of configurations and arrangements of method for correlating a plurality of messages conforming to different protocols. It is understood that various omissions, substitutions of equivalents are contemplated as circumstances may suggest or render expedient, but the present invention is intended to cover the application or implementation without departing from the spirit or scope of the claims.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A method for correlating a plurality of messages conforming to different protocols and associated with a common communication call in a communication network, comprising the steps of:
extracting an information from a message;
extracting a protocol specific identifier to identify the protocol to which the message conforms, such that all the messages conforming to the same protocol have the same protocol specific identifier;
forming a plurality of protocol specific queues, such that messages having same protocol specific identifier are in same queue;
forming a correlation ID using the information extracted from the message and the protocol specific identifier of the message, such that the messages associated with the same communication call have same correlation ID; and
forming a call specific queue comprising of messages extracted from the plurality of protocol specific queues associated with the same common communication call and having same correlation ID.

2. The method according to claim 1, further comprising the processing of messages from the call specific queue with FIFO criterion.

3. The method according to claim 1, wherein the message is a telecom message in a telecommunication network.

4. The method according to claim 1, wherein the protocols are telecom and messaging protocols from a list including a SIP, a HTTP, a MGCP, a Diameter, a CAP, a MAP, an INAP, a SMTP, a SMPP protocols or a combination thereof.

5. The method according to claim 1, wherein the message includes a data.

6. The method according to claim 5, wherein the protocol includes a format of the data.

7. The method according to claim 1, wherein the step of extracting information and the protocol specific identifier from the message is done based on a pre-defined set of rules.

8. The method according to claim 7, wherein the pre-defined set of rules are different for different protocols.

9. The method according to claim 1, wherein the step of forming the correlation ID is based on a pre-defined set of rules.

10. The method according to claim 9, wherein the pre-defined set of rules are different for different protocols.

11. The method according to claim 1, wherein the correlation ID includes a plurality of call context specific identifiers.

12. The method according to claim 1, wherein the correlation ID is saved in a memory of a system where the method of claim 1 is applied.

13. The method according to claim 1, further comprising mapping of the protocol specific identifiers from each of the different protocols with the correlation ID.

14. The method according to claim 13, further comprising routing the subsequent messages by identifying the protocol specific identifier and using the mapping of the protocol specific identifiers with the correlation ID.
